(19) United States
(12) Patent Application Publication
(10) Pub. No.: US 2007/0065209 A1
(43) Pub. Date: Mar. 22, 2007

(54) Apparatus and method of forming image using ribbon cartridge

(75) Inventors: Mi-jung Jang, Suwon-si (KR); Hyun-soo Oh, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/513,379

(22) Filed: Aug. 31, 2006

(30) Foreign Application Priority Data
Sep. 22, 2005 (KR) 2005-88214

(51) Int. Cl. B41J 2/325

(52) U.S. Cl. 400/120.02

(57) ABSTRACT

An apparatus and method of forming an image using a ribbon include displaying a user interface screen to select a type of an over-coating ribbon provided in the ribbon cartridge, printing an image on a printing medium using respective color ribbons provided in the ribbon cartridge, and over-coating the printed printing medium using a selected over-coating ribbon.

### CROSS-REFERENCE TO RELATED APPLICATIONS

This application claims the priority of Korean Patent Application No. 10-2005-0088214, filed on Sep. 22, 2005, in the Korean Intellectual Property Office, the disclosure of which is incorporated herein in its entirety by reference.

### BACKGROUND OF THE INVENTION

1. Field of the Invention

The present general inventive concept relates to a dye diffusion thermal transfer (D2T2) type photo printer, and more particularly, to an apparatus and method of forming an image using a ribbon cartridge to overcoat a printing medium in various ways.

2. Description of the Related Art

In a dye diffusion thermal transfer (D2T2) type photo printer, an image is printed on a printing medium using heat transferred by a thermal print head (TPH). Color ribbons provided in a ribbon cartridge are disposed on the printing medium, and the TPH heats the respective color ribbons to attach a dye onto the printing medium, to thereby form the image.

However, the ribbon cartridge for a conventional photo printer uses a transparent colorless ribbon having no patterns for over-coating the printing medium. Thus, a desired color image having various effects cannot be printed on the printing medium in a conventional color ribbon.

### SUMMARY OF THE INVENTION

The present general inventive concept provides an apparatus and method of forming an image using a ribbon cartridge to overcoat a printing medium using various over-coating ribbons.

Additional aspects and advantages of the present general inventive concept will be set forth in part in the description which follows and, in part, will be obvious from the description, or may be learned by practice of the general inventive concept.

The foregoing and/or other aspects and utilities of the present general inventive concept may be achieved by providing a method of forming an image using a ribbon cartridge, including displaying a user interface screen to select a type of an over-coating ribbon provided in the ribbon cartridge, printing the image on a printing medium using respective color ribbons provided in the ribbon cartridge, and over-coating the printed printing medium using a selected over-coating ribbon.

The foregoing and/or other aspects and utilities of the present general inventive concept may also be achieved by providing a computer-readable medium embodied containing executable code to perform a method of forming an image, the method including displaying a user interface screen for selecting a type of an over-coating ribbon provided in the ribbon cartridge, printing the image on a printing medium using respective color ribbons provided in the ribbon cartridge, and over-coating the printed printing medium using a selected over-coating ribbon.

The foregoing and/or other aspects and utilities of the present general inventive concept may also be achieved by providing a method of forming an image using a ribbon cartridge, including printing the image on a printing medium using respective color ribbons provided in the ribbon cartridge, and over-coating the printed printing medium using a special over-coating ribbon provided in the ribbon cartridge.

The foregoing and/or other aspects and utilities of the present general inventive concept may also be achieved by providing a computer-readable medium containing executable code to perform a method of forming an image, the method including printing the image on a printing medium using respective color ribbons provided in the ribbon cartridge and over-coating the printed printing medium using a special over-coating ribbon provided in the ribbon cartridge.

The foregoing and/or other aspects and utilities of the present general inventive concept may also be achieved by providing a method of forming an image using a ribbon cartridge, the method including repeatedly over-coating a printed printing medium using a special over-coating ribbon provided in the ribbon cartridge.

The foregoing and/or other aspects and utilities of the present general inventive concept may also be achieved by providing a computer-readable medium containing executable code to perform a method of forming an image, the method including repeatedly over-coating a printed printing medium using a special over-coating ribbon provided in the ribbon cartridge.

The foregoing and/or other aspects and utilities of the present general inventive concept may also be achieved by providing an apparatus to form an image using a ribbon cartridge, including a user interface unit which displays a user interface screen to select a type of a over-coating ribbon provided in the ribbon cartridge, and a printing unit which prints an image on a printing medium using respective color ribbons included in the ribbon cartridge and over-coats the printed printing medium using the selected over-coated ribbon.

The foregoing and/or other aspects and utilities of the present general inventive concept may also be achieved by providing an apparatus to form an image using a ribbon cartridge, the apparatus including a printing unit which prints an image on a printing medium using respective color ribbons provided in the ribbon cartridge and a special over-coating ribbon provided in the ribbon cartridge to over-coat the printed printing medium by the printing unit.

The foregoing and/or other aspects and utilities of the present general inventive concept may also be achieved by providing an apparatus to form an image using a ribbon cartridge, the apparatus including a printing unit which over-coats repeatedly a printed printing medium using a special over-coating ribbon provided in the ribbon cartridge.

The foregoing and/or other aspects and utilities of the present general inventive concept may also be achieved by providing a cartridge usable in an image forming apparatus, including an over-coating ribbon containing a prepared image to be printed on a printing medium.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a flowchart illustrating an image forming method using a ribbon cartridge according to an embodiment of the present general inventive concept;

FIG. 2 is a view illustrating a ribbon cartridge according to an embodiment of the present general inventive concept;

FIG. 3 is a flowchart illustrating operation 102 of the image forming method of FIG. 1 according to an embodiment of the present general inventive concept;

FIG. 4 is a flowchart illustrating an image forming method using a ribbon cartridge according to another embodiment of the present general inventive concept;

FIGS. 5A and 5B are views illustrating ribbons of a ribbon cartridge according to an embodiment of the present general inventive concept;

FIG. 6 is a flowchart illustrating operation 300 of the image forming method of FIG. 4;

FIG. 7 is a flowchart illustrating an image forming method using a ribbon cartridge according to another embodiment of the present general inventive concept;

FIGS. 8A and B are views illustrating an over-coat only ribbon according to an embodiment of the present general inventive concept;

FIG. 9 is a block diagram illustrating an image forming apparatus using a ribbon cartridge according to an embodiment of the present general inventive concept;

FIG. 10 is a block diagram illustrating an image forming apparatus using the ribbon of FIG. 5; and

FIG. 11 is a block diagram illustrating an image forming apparatus using the over-coat only ribbon cartridge of FIG. 8.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

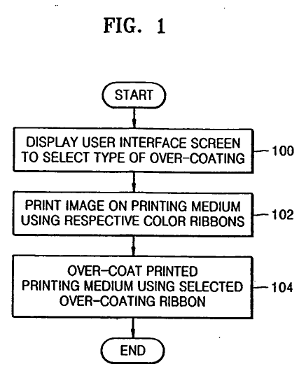

FIG. 1 is a flowchart illustrating an image forming method using a ribbon cartridge according to an embodiment of the present general inventive concept.

A user interface screen is displayed to allow a user to select a desired type of an over-coating ribbon provided in a ribbon cartridge (operation 100). An image is printed on a printing medium using respective color ribbons of the ribbon cartridge (operation 102). The printed printing medium is overcoated according to the selected over-coating ribbon (operation 104).

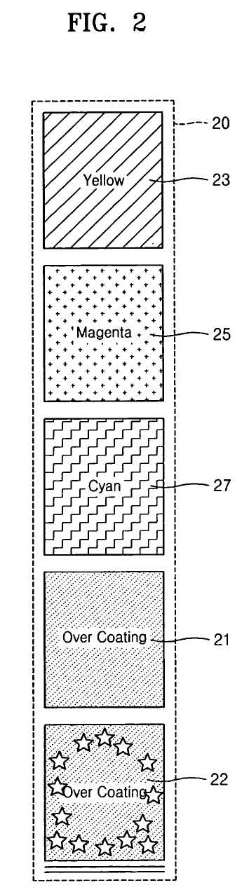

FIG. 2 is a view illustrating a ribbon cartridge 20 according to an embodiment of the present general inventive concept. Referring to FIG. 2, the ribbon cartridge 20 includes a special over-coating ribbon 22, a general over-coating ribbon 21, a yellow ribbon 23, a magenta ribbon 25, and a cyan ribbon 27. The yellow, magenta, and cyan ribbons 23, 25, and 27 can be used to form images on a printing medium. The general over-coating ribbon 21 is a transparent colorless over-coating ribbon. The special over-coating ribbon 22 can print various images on the printing medium. For example, the special over-coating ribbon 22 may be a glossless ribbon or a ribbon having various patterns. The ribbon cartridge 20 may be used in the method of FIG. 1. In addition, the ribbon cartridge 20 may includes any number of color ribbons.

The user interface screen may be displayed on a display screen of a photo printer or on a host computer connected to the photo printer, and the user can select either of the general or special over-coating ribbons 21 and 22 through the user interface screen. The ribbon cartridge 20 may include a number of over-coating ribbons available from which the user can select.

After operation 100, an image is printed on the printing medium using respective color ribbons 23, 25, and 27 provided in the ribbon cartridge (operation 102).

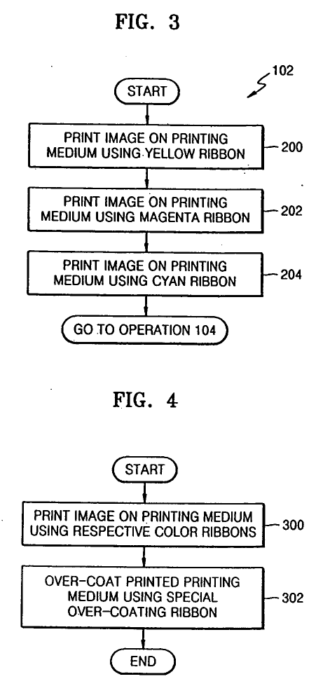

FIG. 3 is a flowchart illustrating operation 102 of the image forming method of FIG. 1 according to an embodiment of the present general inventive concept.

First, the image is printed on the printing medium using, for example, the yellow ribbon 23 (operation 200). Thus, a yellow image is printed on the printing medium. A process of printing the image on the printing medium using the color ribbons 23, 25, and 27 is well known, and thus descriptions thereof will be omitted.

After operation 200, the image is printed on the printing medium using the magenta ribbon 25 (operation 202). Thus, a magenta image is printed on the printing medium, on which the yellow image has been printed.

After operation 202, the image is printed on the printing medium using the cyan ribbon 27 (operation 204). Thus, a cyan image is printed on the printing medium, on which the yellow and magenta images have been printed.

After operation 102, the printed printing medium is over-coated using either of the selected general or special over-coating ribbons 21 or 22 (operation 104). The printed printing medium is over-coated using either of the general or special over-coating ribbons 21 or 22 selected by the user through the user interface screen in operation 100. For example, if the user selects the special over-coating ribbon 22, the printing medium is over-coated using the special over-coating ribbon 22. Thus, an image including various patterns (for example a star pattern) that the user desires is obtained.

FIG. 4 is a flowchart illustrating an image forming method using a ribbon cartridge according to another embodiment of the present general inventive concept.

The image is printed on the printing medium using respective color ribbons provided in the ribbon cartridge (operation 300). The printed printing medium is over-coated using a special over-coating ribbon of the ribbon cartridge (operation 302).

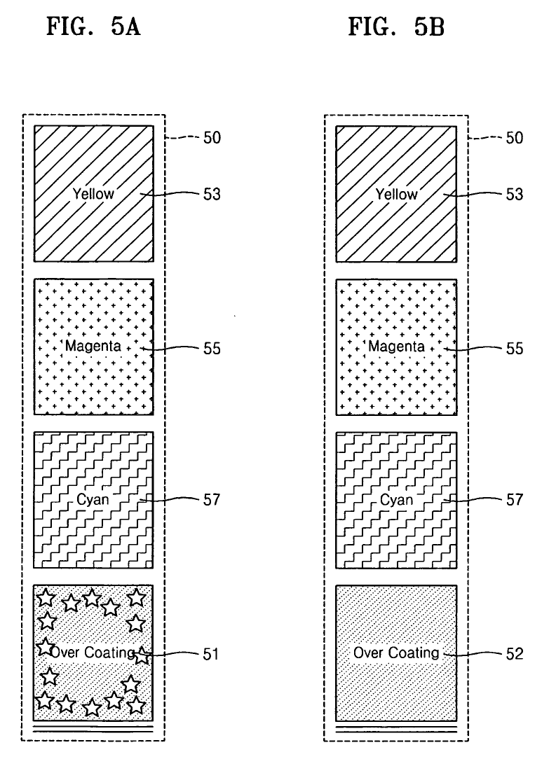

FIGS. 5A and 5B are views illustrating ribbons of a ribbon cartridge 50 according to an embodiment of the present general inventive concept. Referring to FIGS. 5A and 5B, the ribbon cartridge 50 can contain a first special over-coating ribbon 51, illustrated in FIG. 5A, or a second special over-coating ribbon 52, illustrated in FIG. 5B. The ribbon cartridge 50 also includes various color ribbons, for example, a yellow ribbon 53, a magenta ribbon 55, and a cyan ribbon 57. The first and second ribbon cartridges 51 and 52 may be used in the method illustrated in FIG. 4.

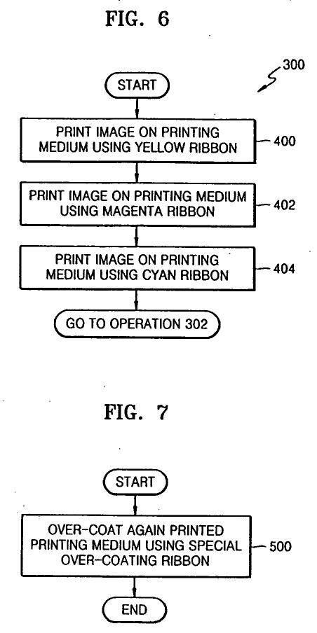

FIG. 6 is a flowchart illustrating operation 300 of the image forming method of FIG. 4 according to an embodiment of the present general inventive concept.

First, the image is printed on the printing medium using the yellow ribbon 53 (operation 400). Thus, a yellow image is printed on the printing medium.

After operation 400, the image is printed on the printing medium using the magenta ribbon 55 (operation 402). Thus, a magenta image is printed on the printing medium, on which the yellow image has been printed.

After operation 402, the image is printed on the printing medium using the cyan ribbon 57 (operation 404). Thus, a cyan image is printed on the printing medium, on which the yellow and magenta images have been printed.

After operation 300, the printed printing medium is over-coated using the special over-coating ribbon 51 or 52 provided in the ribbon cartridge 50 (operation 302). The special over-coating ribbon 51 or 52 can print various images on the printing medium. The special over-coating ribbon 51 or 52 can be a glossless ribbon 52 or a ribbon having various patterns 51.

Referring to FIGS. 4, 5A, and 5B, the ribbon cartridge 50 may include either of the first or second special over-coating ribbons 51 and 52, instead of the general over-coating ribbon. The first special over-coating ribbon 51 can be a transparent over-coating ribbon having a star pattern. The second special over-coating ribbon 52 can be a glossless ribbon.

The printing medium printed in operation 300 is over-coated using ether of the first or second special over-coating ribbons 51 and 52 of FIGS. 5A and 5B. Thus, an image having various patterns that the user desires is obtained.

FIG. 7 is a flowchart illustrating an image forming method using a ribbon cartridge according to another embodiment of the present general inventive concept. Referring to FIG. 7, a printed printing medium is repeatedly over-coated using a special over-coating ribbon (operation 500).

An image including various patterns can be obtained by repeatedly over-coating the printed printing medium using the special over-coating ribbon. The special over-coating ribbon is a special over-coating ribbon and can be any one of a glossless ribbon and a ribbon having various patterns.

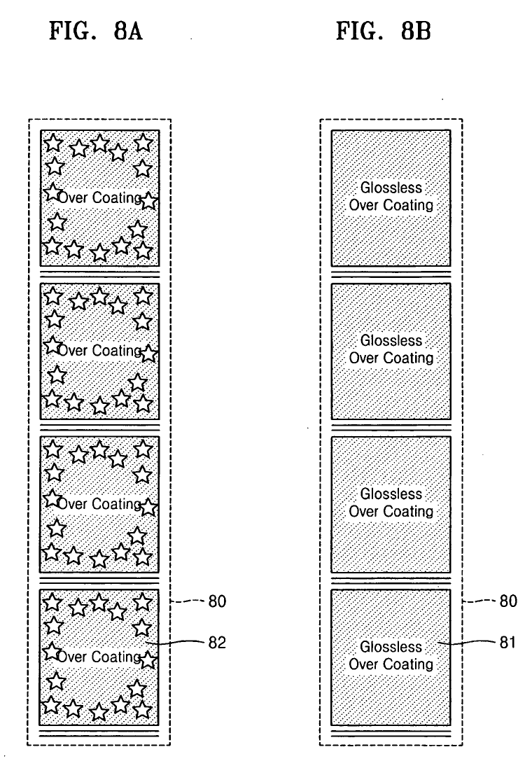

FIGS. 8A and B are views illustrating an over-coat only ribbon cartridge 80 according to an embodiment of the present general inventive concept. Referring to FIGS. 8A and 8B, the over-coat only ribbon cartridge 80 may include either of special over-coating ribbons 81 and 82. FIG. 8A is a view illustrating the special over-coating ribbon 81 having a star pattern. FIG. 8B is a view illustrating the glossless special over-coating ribbon 82. The over-coat only ribbon cartridge 80 may be used to perform the method of FIG. 7 includes only the special over-coating ribbons 81 and 82, instead of color ribbons. The special over-coating ribbons 81 and 82 are used to over-coat the printed printing medium.

The user may use the printed printing medium, and over-coat the printed printing medium again using one of the special over-coating ribbons 81 and 82 of FIGS. 8A and 8B, for example.

Meanwhile, the embodiments of the present general inventive concept can be written as computer code/instructions/programs and can be implemented in general-use digital computers that execute the programs using a computer readable recording medium.

Examples of the computer readable recording medium include magnetic storage media (e.g., ROM, floppy disks, hard disks, etc.), optical recording media (e.g., CD-ROMs, or DVDs), and storage media such as carrier waves (e.g., transmission through the Internet). In addition, the computer readable recording medium can also be distributed over network coupled computer systems so that the computer readable code is stored and executed in a distributed fashion.

Also, functional programs, code, and code segments to accomplish the present general inventive concept can be easily construed by programmers skilled in the art to which the present general inventive concept pertains.

Hereinafter, an apparatus of embodiments of the present general inventive concept will be described with reference to the accompanying drawings.

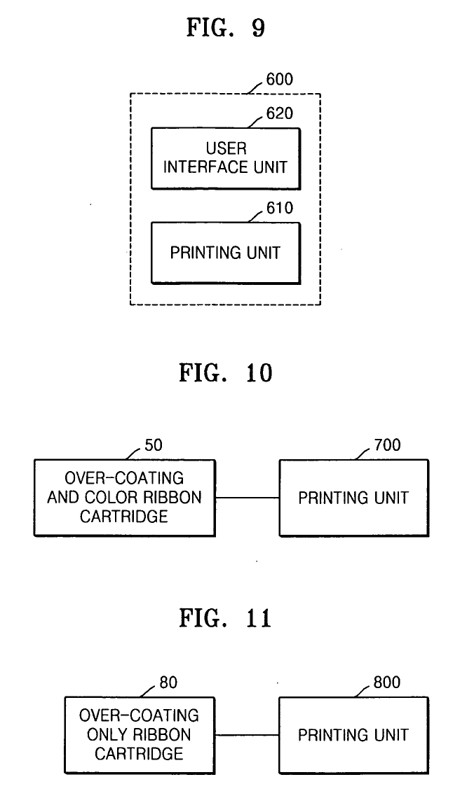

FIG. 9 is a block diagram illustrating an image forming apparatus 600 using a ribbon cartridge according to an embodiment of the present general inventive concept. Referring to FIG. 9, the image forming apparatus 600 includes a user interface unit 620 and a printing unit 610.

The user interface unit 620 displays a user interface screen to allow a user to select a type of an over-coating ribbon provided in the ribbon cartridge.

For example, the user interface unit 620 may be provided on the printing unit 610, such as a photo printer, so that the user interface screen can be displayed on a display screen of the photo printer. In another example, the user interface unit 620 may be provided in a host computer, so that the user interface screen can be displayed on a display screen of the host computer. The user can select a desired over-coating ribbon through the user interface screen of the user interface unit 620.

Referring to FIGS. 2 and 9, the ribbon cartridge 20 includes the special over-coating ribbon 21 and a general over-coating ribbon 22. The special over-coating ribbon 22 can be any one of a glossless ribbon and a ribbon having various patterns. The image forming apparatus 600 may use the ribbon cartridge 20 having the special over-coating ribbon 22, the general over-coating ribbon 21, and the yellow, magenta, and cyan ribbons 23, 25, and 27.

The printing unit 610 prints the image onto the printing medium using respective color ribbons provided in the ribbon cartridge, and the printed printing medium is over-coated using the selected over-coating ribbon, depending on the type of over-coating ribbon provided.

With reference to the ribbon cartridge of FIGS. 2 and 3, the printing unit 610 respectively prints images on the printing medium using yellow, magenta, and cyan ribbons 23, 25, and 27.

Referring to FIGS. 2 and 9, if the user selects the special over-coating ribbon 22 of FIG. 2, the printing unit 610 over-coats the printed printing medium using the selected special over-coating ribbon 22. The printing medium over-coated using the special over-coating ribbon 22 is printed out, thereby obtaining the image including the desired patterns.

FIG. 10 is a block diagram illustrating an image forming apparatus using the ribbon cartridge 50 of FIG. 5 according to another embodiment of the present general inventive concept. Referring to FIGS. 5A, 5B, and 10, the image forming apparatus includes a printing unit 700. It is possible that the ribbon cartridge 50 is included in the printing unit 700.

The printing unit 700 prints the image on the printing medium using respective color ribbons provided in the ribbon cartridge 50, and the printed printing medium is over-coated using the special over-coating ribbon 51 or 52 provided in the ribbon cartridge 50.

The printing unit 700 respectively prints images on the printing medium using the yellow, magenta, and cyan color ribbons 53, 55, and 57, respectively.

The special over-coating ribbon 51 or 52 can be any one of the glossless ribbon 52 and the ribbon having various patterns 51. The ribbon cartridge 50 includes either one of the special over-coating ribbons 51 and 52, instead of the general over-coating ribbon.

FIG. 11 is a block diagram illustrating an image forming apparatus using the over-coat only ribbon cartridge 80 of FIG. 8 according to another embodiment of the present general inventive concept. Referring to FIGS. 8A, 8B, and 11, the image forming apparatus includes a printing unit 800. It is possible that the ribbon cartridge 80 is included in the printing unit 800. The printing unit 800 repeatedly over-coats the printed printing medium using the special over-coating ribbon 81 or 82 provided in the ribbon cartridge 80. The ribbon cartridge 80 can have either or the first and second special over-coating type ribbon 81 and 82 provided therein.

An image having various patterns can be obtained by repeatedly over-coating the printed printing medium using either of the special over-coating ribbons 81 or 82. As illustrated in FIGS. 8A and B, the ribbon cartridge 80 to perform the method of FIG. 7 includes only special over-coating ribbons 81 or 82, instead of color ribbons. The over-coating only ribbon 80 is used only to over-coat the printed printing medium.

When the user uses the printed printing medium again, the printing unit 800 repeatedly over-coats the printed printing medium using the ribbon cartridge 810 including the special over-coating ribbons of FIGS. 8A and B, for example.

As described above, by varying an apparatus and method of forming an image using a ribbon cartridge of the present general inventive concept, various photo images (for example, a gold or silver foiled image and a glossless image) can be obtained, which cannot be obtained by using conventional ribbon colors, by using various over-coating ribbons.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A method of forming an image using a ribbon cartridge, comprising:
displaying a user interface screen to select a type of an over-coating ribbon provided in the ribbon cartridge;
printing the image on a printing medium using respective color ribbons provided in the ribbon cartridge; and
over-coating the printed printing medium using a selected over-coating ribbon provided in the ribbon cartridge.

2. The method of claim 1, wherein the ribbon cartridge comprises a special over-coating ribbon.

3. The method of claim 2, wherein the special over-coating ribbon is any one of a glossless ribbon and a ribbon having various patterns.

4. The method of claim 1, wherein the printing of the image comprises:
printing the image on the printing medium using a yellow ribbon among the respective color ribbons;
printing the image on the printing medium using a magenta ribbon among the respective color ribbons; and
printing the image on the printing medium using a cyan ribbon among the respective color ribbons.

5. A computer-readable medium containing executable code to perform a method of forming an image, the method comprising:
displaying a user interface screen for selecting a type of an over-coating ribbon provided in the ribbon cartridge;
printing the image on a printing medium using respective color ribbons provided in the ribbon cartridge; and
over-coating the printed printing medium using a selected over-coating ribbon.

6. A method of forming an image using a ribbon cartridge, comprising:
printing the image on a printing medium using respective color ribbons provided in the ribbon cartridge; and
over-coating the printed printing medium using a special over-coating ribbon provided in the ribbon cartridge.

7. The method of claim 6, wherein the special ribbon is any one of a glossless ribbon and a ribbon having various patterns.

8. The method of claim 6, wherein the printing of the image comprises:
printing the image on the printing medium using a yellow ribbon among the respective color ribbons;
printing the image on the printing medium using a magenta ribbon among the respective color ribbons; and
printing the image on the printing medium using a cyan ribbon among the respective color ribbons.

9. A computer-readable medium containing executable code to perform a method of forming an image, the method comprising:
printing the image on a printing medium using respective color ribbons provided in the ribbon cartridge; and
over-coating the printed printing medium using a special over-coating ribbon provided in the ribbon cartridge.

10. A method of forming an image using a ribbon cartridge, the method comprising repeatedly over-coating a printed printing medium using a special over-coating ribbon provided in the ribbon cartridge.

11. The method of claim 10, wherein the special ribbon is one of a glossless ribbon and a ribbon having various patterns.

12. A computer-readable medium containing executable code to perform a method of forming an image, the method comprising:
repeatedly over-coating a printed printing medium using a special over-coating ribbon provided in the ribbon cartridge.

13. An apparatus to form an image using a ribbon cartridge, comprising:
a user interface unit which displays a user interface screen to allow a user to select a type of a over-coating ribbon provided in the ribbon cartridge; and
a printing unit which prints an image on a printing medium using respective color ribbons included in the ribbon cartridge and over-coats the printed printing medium using the selected over-coated ribbon.

14. The apparatus of claim 13, wherein the ribbon cartridge comprises a special over-coating ribbon, besides a general over-coating ribbon.

15. The apparatus of claim 14, wherein the special ribbon is one of a glossless ribbon and a ribbon having various patterns.

16. The apparatus of claim 13, wherein the printing unit prints the image on the printing medium using a yellow ribbon among the respective color ribbons, prints the image on the printing medium using a magenta ribbon among the respective color ribbons, and prints the image on the printing medium using a cyan ribbon among the respective color ribbons.

17. An apparatus to form an image using a ribbon cartridge, comprising:
a printing unit which prints an image on a printing medium using respective color ribbons provided in the ribbon cartridge; and
a special over-coating ribbon provided in the ribbon cartridge to over-coat the printed printing medium by the printing unit.

18. The apparatus of claim 17, wherein the special ribbon is one of a glossless ribbon and a ribbon having various patterns.

19. The apparatus of claim 17, wherein the printing unit prints the image on the printing medium using a yellow ribbon among the respective color ribbons, prints the image on the printing medium using a magenta ribbon among the respective color ribbons, and prints the image on the printing medium using a cyan ribbon among the respective color ribbons.

20. An apparatus to form an image using a ribbon cartridge comprising:
a printing unit which over-coats repeatedly a printed printing medium using a special over-coating ribbon provided in the ribbon cartridge.

21. The apparatus of claim 20, wherein the special ribbon is any one of a glossless ribbon and a ribbon having various patterns.

22. A cartridge usable in an image forming apparatus, comprising:
an over-coating ribbon containing a prepared image to be printed on a printing medium.

23. The cartridge of claim 22, wherein the over-coating ribbon comprises a special over-coating ribbon.

24. The cartridge of claim 23, wherein the special over-coating ribbon has one of a star pattern, gold foil, and silver foil.

25. The cartridge of claim 22, wherein the over-coating ribbon comprises a glossless ribbon.

26. The cartridge of claim 22, further comprising:
at least one color ribbon to form the image on the printing medium.
